(19) United States
(12) Patent Application Publication
(10) Pub. No.: US 2024/0256981 A1
(43) Pub. Date: Aug. 1, 2024

(54) SELF-ADAPTIVE MULTI-MODEL APPROACH IN REPRESENTATION FEATURE SPACE FOR PROPENSITY TO ACTION

(71) Applicant: HITACHI VANTARA LLC, Santa Clara, CA (US)

(72) Inventors: Mauro A. Damo, Windermere, FL (US); Wei Lin, Plainsboro, NJ (US); William Schmarzo, Palo Alto, CA (US)

(21) Appl. No.: 18/633,131

(22) Filed: Apr. 11, 2024

Related U.S. Application Data
(63) Continuation of application No. 18/030,127, filed on Apr. 4, 2023.

(51) Int. Cl. G06N 20/00

(52) U.S. Cl. CPC G06N 20/00

(57) ABSTRACT

Example implementations described herein are directed to generating time series features from structured data and unstructured data managed in a data lake; executing a feature selection process on the time series features; conducting supervised training on the selected time series features across a plurality of different types of models iteratively to generate a plurality of models; selecting a best model from the plurality of models for deployment; and continuously retraining the model from the structured and unstructured data while the best model exceeds a predetermined criteria.

### CROSS REFERENCE TO RELATED APPLICATION

The present application is a continuation of U.S. patent application Ser. No. 18/030,127, filed on Apr. 4, 2023, which in turn is a national phase entry of international patent application No. PCT/US2020/055380 filed on Oct. 13, 2020, the disclosure of which is expressly incorporated herein by reference.

### BACKGROUND

### Field

The present disclosure is generally directed to machine learning, and more specifically, to machine learning frameworks for feature selection to facilitate model generation.

### Related Art

In the related art, determining propensity for action is a challenging problem for data scientists who want to compute the likelihood of what, when, and where the next action of an entity will occur in the future. An entity can be a person, organization, or institution and the action can be a purchase, donation, or financial transaction. Predicting the next action of an entity is a problem of probability such that data scientists need to consider multiple uncertainties around the action.

In related art implementations, a model with structured and unstructured data cannot mix numeric data with text data. When training a model, only mathematical functions are used in the training sets. Text cannot be used in a function.

Related art implementations can also encounter data sparsity, or the lack of available data for modeling, is a problem for Machine Learning (ML) and Artificial Intelligence (AI) models. When there is not enough data to embed in a model, the outcome contains a lot of uncertainty while lacking accuracy.

The integrity of data quality is another common data problem in the ML and AI implementations of the related art. Missing data, data entry problems, and data outliers are major concerns in modeling because those problems do not reflect real data and result in increased errors.

Prioritizing the importance of some data sets over other data sets also impacts modeling. Determining which data is relevant for a model and which data is less important is a challenge for data scientists. The minimal set of variables with the highest accuracy is the best possible configuration of variables.

Concept drift in modeling occurs when the model starts to experience performance degradation. When the model reaches a degradation threshold, the values or scores are not accurate, resulting in errors.

When a system receives more additional data, the data could improve the model and its performance provided that the data scientist retrains the model with the new data. However, to adapt the current model data schema to a new data schema requires extensive work.

### SUMMARY

Example implementations described herein involve a unified framework that measures the propensity for action of an entity by using historical information of the behavior and by using self-adaption of the features. The algorithm described herein captures the historical purchase behavior of any entity, such as customers, users, employees, or banks, and gives a likelihood of these entities to make an action such as purchasing, investing, or leaving a job.

To address the propensity for action analysis issues in the related art, example implementations involve a system that automatically generates analytics model that can self-adapt in a multi-model approach and further could be applied for any propensity for action kind of problem. A propensity to action problem is defined as an estimate of the future probability of an entity (p.ex. customer buys a product A, investor invests on stock B, a physician recommends a treatment C) to do specific action (p. ex. buy, investment, recommendation). The computation of such probabilities is done using historical behavior data, self-adapting feature engineering and multi-machine learning models.

To address the propensity for action issues in the related art, example implementations involve a propensity model that computes the likelihood of an entity to perform an action. The self-adaptive model selects the best features from the dataset and then maps it to a latent space to aggregate different variables into features (e.g., the group of variables). Those features come to be the model input. The model further uses machine learning and artificial intelligence to self-identify and self-select the best fit algorithms.

To address the issues regarding creating a model with both structured and unstructured data in the related art, the features in the model in the example implementations can create a numeric representation of text data using term frequency (TF) and inverse document frequency (IDF) along with Latent Dirichlet Allocation (LDA). The related art is a system that creates models for different propensity to action events, in this objective it is crucial to consider non numerical data, like text data, for increasing the wide adoption of the system for the prediction of when an action will occur. These techniques make it possible to apply traditional machine learning models to text data.

To address data sparsity in the related art, example implementations transform data sparsity to data density using a Principal Component Analysis technique (PCA), making it possible to remove data collinearity, build independence between features, and unify the features as input for the model. One traditional problem in machine learning is data dependency between variables, but with PCA it is possible to avoid it.

To address data quality issues in the related art, example implementations described herein use automatic data quality monitoring and selection techniques for data selection. Selection data quality is improved by removing outliers after normalization computation, filtering out data entry problems, and treating the missing values using interpolation techniques.

Based on a time window, example implementations described herein involve a method that evolves keyword importance over time and uses an automatic approach for feature generation to address issues in data importance. For example, the selected feature has a predefined time window of 30 days, 60 days, and 180 days. In this time window, the data is aggregated. When it finds a data density, the feature is created. Note that if the data density is below a specific threshold of the potential data, the feature is discarded. This time series component necessary for future prediction of actions and the usage of time series as factor for the creation of features increases the prediction power of the machine learning models

To address concept drift in predictive models, example implementations described herein involve a procedure to automatically detect, create, and retrain a new model after detection of performance degradation. The concept of model drift allows the system to continuously learning the new data patterns using newness data reducing the model error. Two kinds of detection can be utilized.

1. Frequency based: The threshold is based on model accuracy. For example, if the training of a model shows accuracy of less than 90%, example implementations can create or retrain a new model and the model will improve its accuracy.

2. Magnitude based: The magnitude is based on the variance of the model accuracy. For example, if the variance of the model performance increases for a specific threshold, example implementations thereby creates or trains the model.

To add new data to models, example implementations described herein uses the procedure to detect a feature and automatically select the best fit of the features to create the best model. This procedure can increase or decrease the data source based on what is needed for the model to perform better. This approach ranks a data source automatically by applicable use case and uses adaptive processing of the feature selection for optimal model results. For example, if a use case has three datasets and if a group of instances has data only in two of three datasets, the example implementations will run a model for this group of instances. The approach runs different models for different sets of instances based on the data availability.

Aspects of the present disclosure can involve a method, which can include a) generating time series features from structured data and unstructured data managed in a data lake; b) executing a feature selection process on the time series features; c) conducting supervised training on the selected time series features across a plurality of different types of models iteratively to generate a plurality of models; d) selecting a best model from the plurality of models for deployment; and e) continuously iterating a) to d) while the best model exceeds the predetermined criteria.

Aspects of the present disclosure can involve a computer program, storing instructions which can include a) generating time series features from structured data and unstructured data managed in a data lake; b) executing a feature selection process on the time series features; c) conducting supervised training on the selected time series features across a plurality of different types of models iteratively to generate a plurality of models; d) selecting a best model from the plurality of models for deployment; and e) continuously iterating a) to d) while the best model exceeds the predetermined criteria. The instructions can be stored on a non-transitory computer readable medium and executed by one or more processors.

Aspects of the present disclosure can involve an apparatus, which can include a processor configured to a) generate time series features from structured data and unstructured data managed in a data lake; b) execute feature selection process on the time series features; c) conduct supervised training on the selected time series features across a plurality of different types of models iteratively to generate a plurality of models; d) select a best model from the plurality of models for deployment; and e) continuously iterate a) to d) while the best model exceeds the predetermined criteria.

Aspects of the present disclosure can involve a system, which can include a) means for generating time series features from structured data and unstructured data managed in a data lake; b) means for executing a feature selection process on the time series features; c) means for conducting supervised training on the selected time series features across a plurality of different types of models iteratively to generate a plurality of models; d) means for selecting a best model from the plurality of models for deployment; and e) means for continuously iterating a) to d) while the best model exceeds the predetermined criteria.

### BRIEF DESCRIPTION OF DRAWINGS

FIG. 1(a) illustrates an overall flow diagram of the example implementations described herein.

FIG. 1(b) illustrates an overall architecture of the example implementations described herein.

FIG. 2 illustrates an example architecture for the structured and unstructured data, in accordance with an example implementation.

FIG. 3 illustrates feature and dimension reduction, in accordance with an example implementation.

FIG. 4 illustrates an example of data scientist fine tuning, in accordance with an example implementation.

FIG. 5(a) illustrates an example of supervised training, in accordance with an example implementation.

FIG. 5(b) illustrates an example flow of supervised training, in accordance with an example implementation.

FIG. 5(c) illustrates an example flow diagram for the automatic features selection, in accordance with an example implementation.

FIG. 5(d) illustrates an example of generation of time-series data from pre-set definitions, in accordance with an example implementation.

FIG. 5(e) illustrates a flow for selecting the most important features from the feature generation, in accordance with an example implementation.

FIG. 5(f) illustrates a flow for defining hyperparameter ranges, in accordance with an example implementation.

FIG. 5(g) illustrates a flow for process of Model Training and Model selection, in accordance with an example implementation.

FIG. 6 illustrates an example of the explainable AI, in accordance with an example implementation.

FIG. 7(a) illustrates an example of the scoring, in accordance with an example implementation.

FIG. 7(b) illustrates an example of the output that can be provided with custom messages, in accordance with an example implementation.

FIG. 8 illustrates an example of the output dashboard, in accordance with an example implementation.

FIG. 9 illustrates an example computing environment with an example computer device suitable for use in some example implementation.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations. In the present disclosure, supervised training can involve any supervised machine learning technique in accordance with the desired implementation.

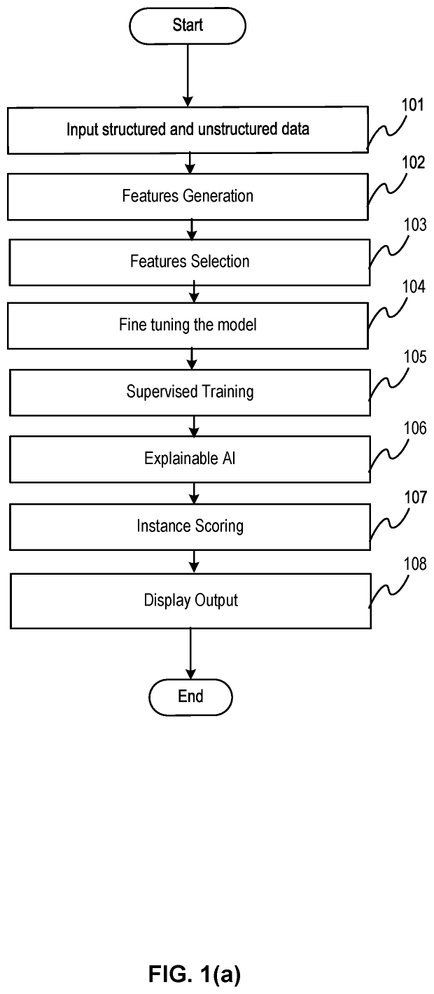

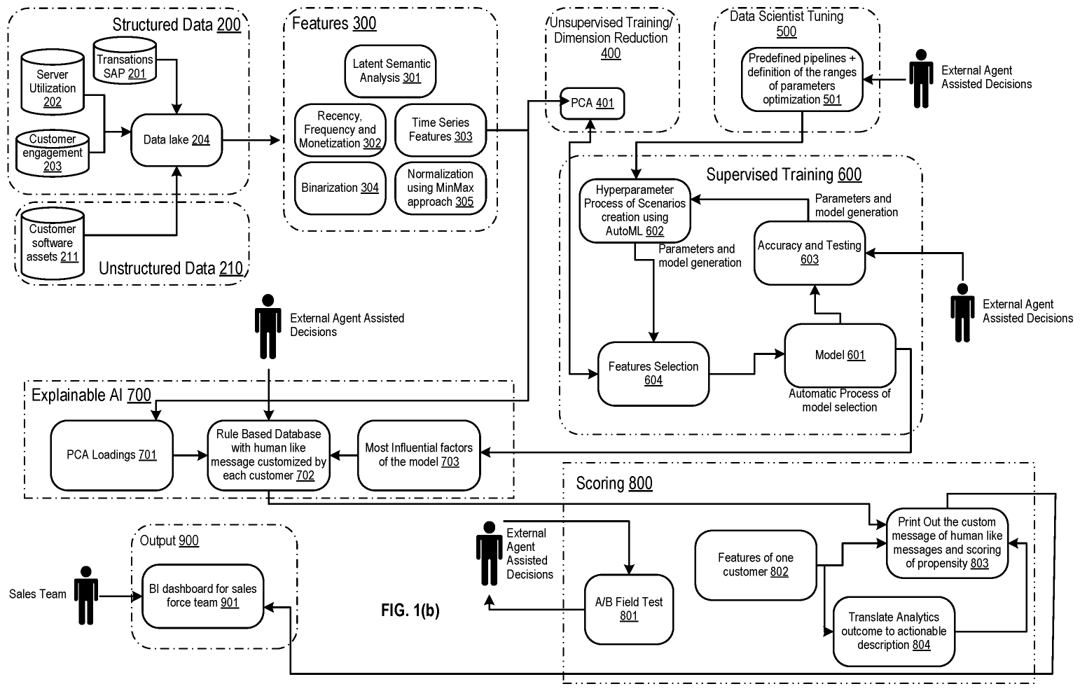

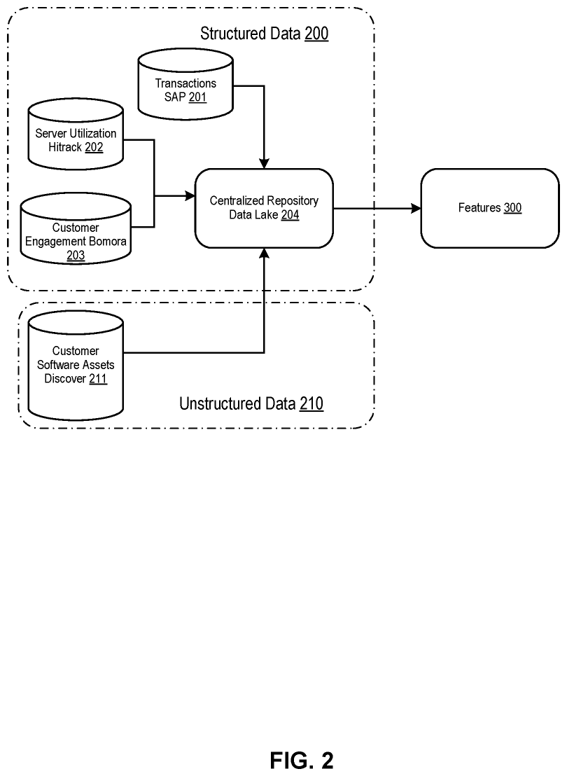

FIG. 1(a) illustrates an overall flow diagram of the example implementations described herein. Example implementations described herein first intake structured and unstructured data to extract all data sets from the input data at 101. At 102, the flow generates features from the input data. At 103, the flow selects the main features and variables from datasets using ranking criteria. At 104, the flow selects the range of parameters to put in the model training phase. At 105, the flow conducts multiple iterations of supervised training using multiple hyperparameters and then selects the best algorithm from the trained algorithms. At 106, the flow provides an explanation for the most important features from the best model. At 107, the flow scores the new instances of the data using the best model. At 108, the flow outputs the results on a display. Each of the flows in the flow diagram of FIG. 1(a) is explained in further detailed herein as follows. Further, each of the flows is also tied with the overall architecture illustrated in FIG. 1(b), which will be described in more detail with respect to FIGS. 2-8 as follows.

For the input of structured and unstructured data 101, to begin the process, the process links different datasets from different data sources in the same fact table, examples of which are illustrated as 201, 202, 203, and 211. Those datasets are centralized in one data lake 204, which is a data repository that contains several datasets which are ingested from different data sources like transactional systems and third-party systems. FIG. 2 illustrates an example architecture for the structured 200 and unstructured data 210, in accordance with an example implementation.

At 102, to generate features from the input data, example implementations utilize a combination of all of the feature procedures in FIG. 2. Specifically, example implementations mix structured 200 and unstructured data 210, such as mixing numeric data with text data, and apply a temporal component in those features. It is a predefined data range that can be defined before executing the process, making the algorithm create all multidimensional features using time as an input variable.

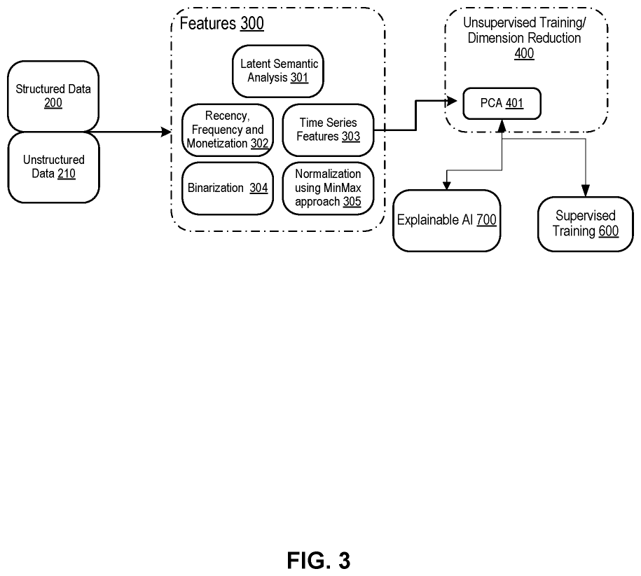

FIG. 3 illustrates feature and dimension reduction, in accordance with an example implementation. Features 300 can involve a technique called Latent Semantic Analysis 301 for topic modeling of the text data. The input data involves customer account data of each instance of the dataset (rows) and technology, both software and hardware, from each customer. Latent Semantic Analysis 301 can involve two steps. The first step uses term frequency and inverse document frequency (TFIDF) to create a numeric representation of the words. The second step applies a Singular Value Decomposition method (SVD) to create a group of technologies that has a similar preference to customers.

Features 300 can also involve Recency, Frequency, and Monetization 302 and involves three features. Recency refers to how recently a customer has made a purchase, while Frequency refers to how often a customer makes a purchase. Lastly, the feature Monetization refers to how much money a customer spends on purchasing. These features group the customers that have similar behavior in different groups.

Features 300 can also involve time series features 303 which involves a temporal component in Recency, Frequency, and Monetization 302. This temporal addition works by computing Recency, Frequency, and Monetization 302 for different time ranges. For example, Frequency is the number of purchases a customer makes in a specific period of time: the number of purchases a customer makes in the last one month, the last three months, the last six months, and so on. The combination of these two procedures are referred herein as Temporal RFM. Timer series features 303 are forwarded to the unsupervised training/dimension reduction 400 process to conduct Principal Component Analysis 401, the analysis of which is forwarded to explainable AI 700 and supervised training 600.

MinMax 305 is applied to each group of temporal RFM. The MinMax 305 technique is a normalization process that has the goal to normalize features. Normalization involves adjusting values measured on different scales to a notionally common scale.

The Binarization approach 304 is applied to categorical variables which creates a binary representation of each category. For example, if in a dataset, a set has a variable called company revenue and has three possible categories such as ‘high’, ‘medium’, and ‘low’ revenue, a customer with ‘high’ revenue will be represented as a vector with elements [1,0,0].

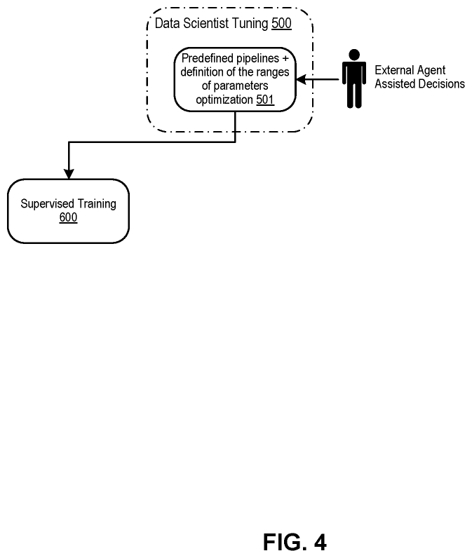

FIG. 4 illustrates an example of data scientist fine tuning 500, in accordance with an example implementation. At 104, to facilitate model fine tuning, the hyperparameters are added to input in the model based on the heuristic decision of the data scientist. This flow involves the creation of the set of parameters 501 that create the several scenarios of different algorithms, which can be created by the data scientist in accordance with the desired implementation. Creating the algorithms is completely automated, with just a predefined set of parameters.

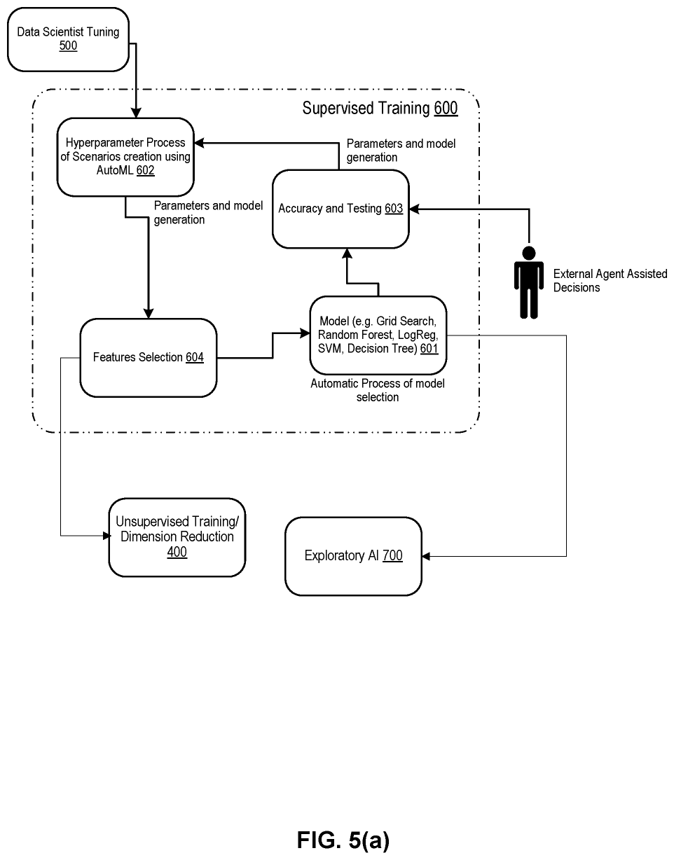

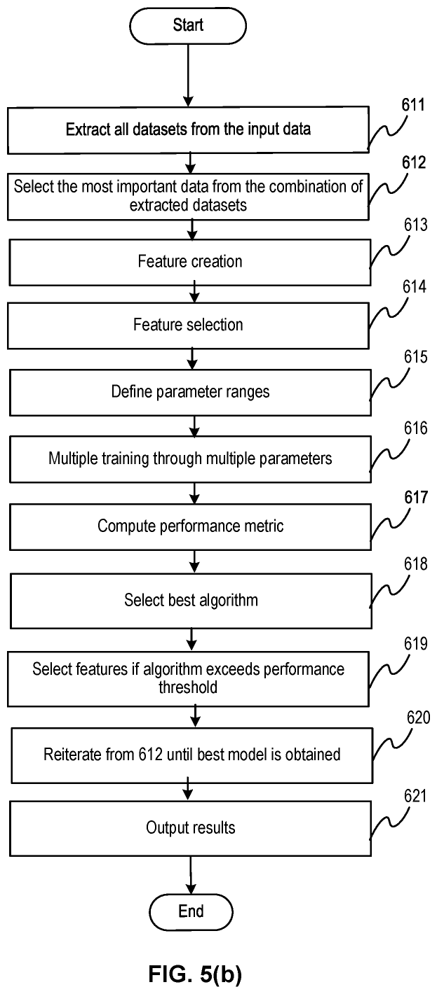

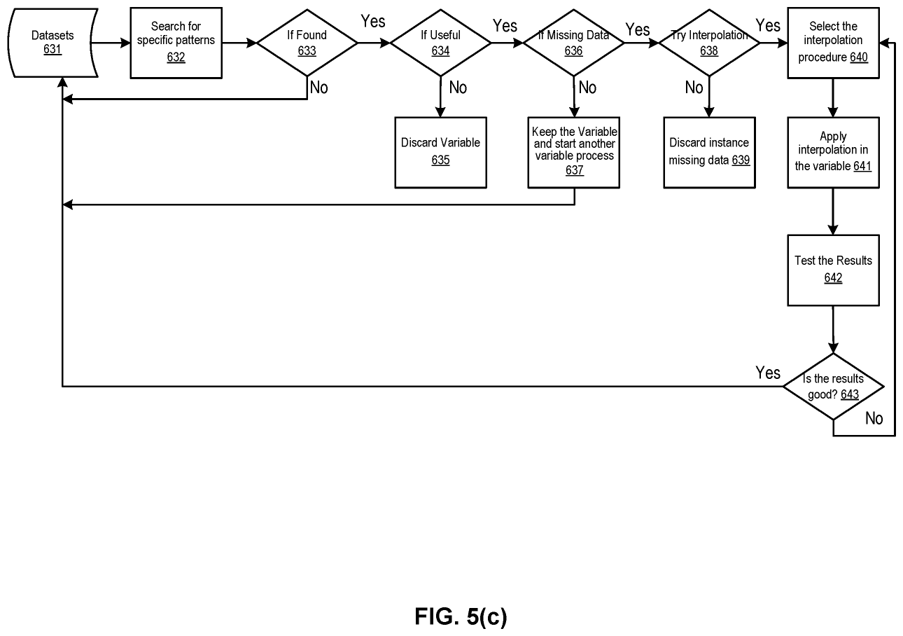

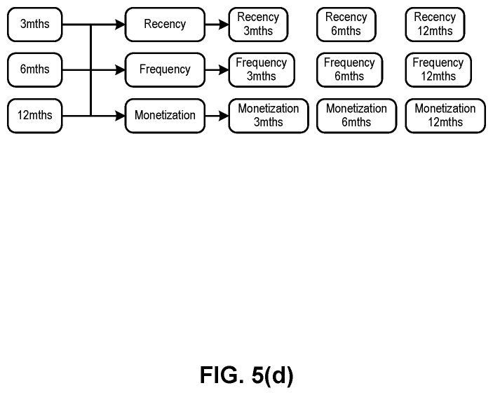

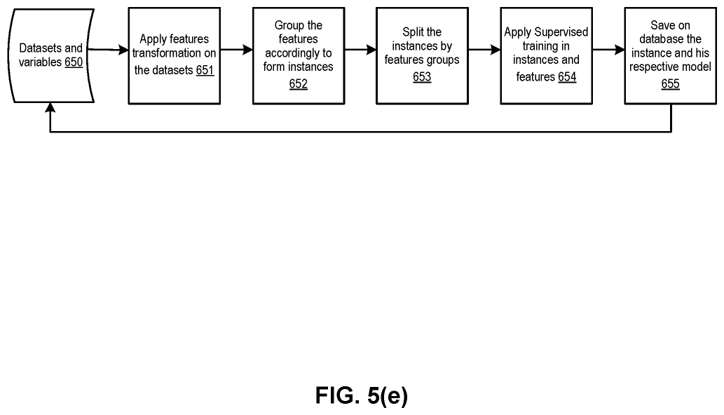

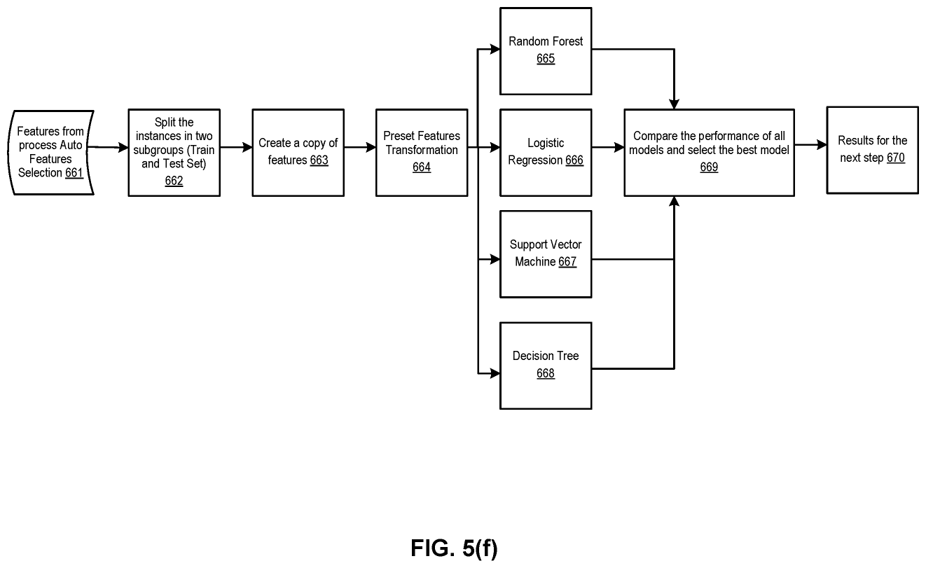

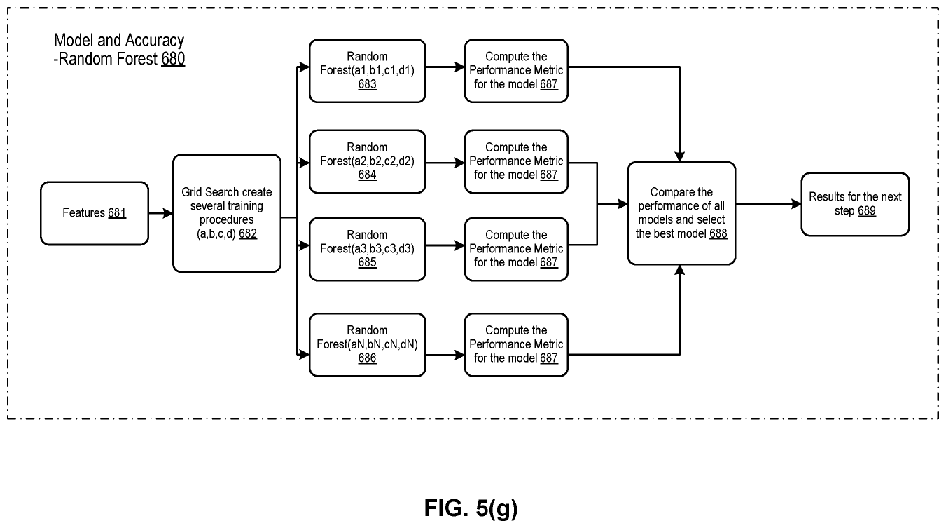

FIG. 5(a) illustrates an example of supervised training, in accordance with an example implementation. At 105, the example implementations of supervised training 600 focuses on producing data quality and data density using self-adaption mechanisms for improving system performance.

Model 601 is the process when a model is trained for several different models. Hyperparameter process 602 is the process of hyperparameters selection. These hyperparameters are made using an automatic process of selecting the best hyperparameters from several different combinations. Accuracy and testing 603 involves measuring the accuracy of several models that are built and then testing those models. Here is also the selection of the model which is the best one to use for the inference phase.

Features selection 604 involves the phase for selecting the features that generate the model with the best results. The features combination is also added to the combinations of hyperparameters. The final result of supervised training 600 is the best performing combination of both features and hyperparameters.

The supervised training includes the following flow as illustrated in FIG. 5(b).

At 611, the flow extracts all datasets from the input data.

At 612, the flow selects the most important data from the combination of extracted datasets. In the flow of 612, the system automatically will select the best datasets and their variables based on the quality of the dataset. The system will perform relative computations in dataset information. For example, in a dataset for each variable, the system can compute the ratio of missing values compared to the total number of instances. Through such implementations, several procedures will be applied to the datasets, such as removing missing values in non-continuous variables and interpolating missing values inside of continuous variables. Further details for the automatic features selection is outlined with respect to FIG. 5(c).

At 613, the flow creates features. Features are variables that are parsed through a transformation (e.g., square root of a temperature metric) from the multiple combinations of extracted datasets. Features are created when the user defines the target variable. The target variable can be any variable that identifies the instance. Such variables can be a customer that may buy new products, a company that is aiming to acquire a new company, a patient having the propensity to receive medications, and so on. All the features will be built to better identify patterns in the target variable. The target variable can be the historical results of the action that it is studied. For example, in propensity to buy model, the target variable is the purchase of a product. Those patterns will be discovered using data structure using a prebuild set of data functions that will transform the data based on data properties. For example, if the data is continuous variable, the system apply normalization procedures like z-score and MinMax procedures to normalize the data. Another example, if the data is a categorical variable, the system will create a binarization of the categorical variable automatically.

Feature creation involves the functions as illustrated in FIG. 3. For example, for Latent Semantic Analysis 301, example implementations apply singular value decomposition (SVD) on customer information to transform text information and group the instances with the same affinity. Through Recency, Frequency and Monetization (RFM) 302, the recency can involve determining how recently a customer has made a purchase, frequency can involve determining how often a customer makes a purchase, and monetization can involve determining how much money a customer spends on purchases.

Time Series Features 303 can involve automatic feature generation of the RFM model that automatically generates new features using the time frame from the user as parameters. With regards to binarization 304, for the categorical variables, it is all variables that have a category instead of a number. The system will search all variables, identify the type of the variable and if it is a categorical variable, for each category of the original field, the system will create a new variable and will assign a 0 or 1 for each instance of the data set. For example, the system will search every column of the table below and detect the company size variable is a category, then it will transform each category on this field in another variable that will contain 0 and 1.

For normalization 305, the maximum and minimum procedure applies to all continuous variables. This will standardize the data between 0 and 1 and the system automatically will select the right variable.

The pre-definition of the time series that will be created in the dataset will also be defined. As an example, the definition can be 3, 6 and 12 months as illustrated in FIG. 5(d).

At 614, the flow ranks and selects the most important feature(s) from the quality of created features. Further details for the flow of the feature selection for this aspect is described in FIG. 5(e).

At 615, the user, for example, the Data Scientist, Business Analyst, or Data Analyst, defines the range of parameters that will be used in the model using a heuristic method. These parameters will be tested in preset multiple potential models. Each number of the range of parameters generates a set of hyperparameters and each set is a model. FIG. 5(f) illustrates an example implementation for the definition of the range of parameters for incorporating into a model.

At 616, the flow conducts multiple training iterations using multiple hyperparameters in a plurality of learning algorithms using selected feature(s). Note that the total computation effort is a function of the number of scenarios defined in the previous phase. FIG. 5(g) illustrates an example flow involving the training, in accordance with an example implementation.

At 617, the engine computes a performance metric (e.g., accuracy based on the total number of True Positives plus True Negatives divided by all instances) for each of the trained algorithms executed in in the flow at 611. The performance metric is defined based on an algorithm that is executed.

At 618, the flow selects the algorithm with the best metric performance from the trained algorithms. At 619, if there is the algorithm whose calculated performance criterion exceeds the predetermined criteria, then the flow selects the previously unused and used features from the extracted features. In an example implementation, the features selection criteria is the availability of the feature for the instance. For example, consider one instance as one customer. For each group of customers or instances, there exists a different set of features. One feature can be available in a set of features for a group of customers and at the same time it cannot be available for another group of customers. The criteria of availability of a feature is if it exists for all customers in the group. At 620, the flow repeats the flow from 612 until the best fitting model applicable for the available data for each instance is obtained.

In example observations, the classification rate or accuracy is given as (TP+TN)/(TP+TN+FP+FN), wherein TP is the true positive (observation is positive and predicted to be positive), TN is the true negative (observation is negative and predicted to be negative), FP is the false positive (observation is negative but is predicted positive), and FN is the false negative (observation is positive, but is predicted negative). Recall is the ratio of the total number of correctly classified positive examples with the total number of positive examples and can be given as TP/(TP+FN). Precision is the total number of correctly classified positive examples compared to the total number of predicted positive examples, and can be given as TP/(TP+FP). The predetermined criteria can be set based on any of such classification rates, accuracy, recall, or precision in accordance with the desired implementation.

At 621, the flow outputs the result using the selected algorithm.

Through this flow, the example implementations can thereby address the propensity for action analysis issues in the related art through the automatic generation of an analytics model from a plurality of models that is self-adapting through iteration while deployed. The model can be applied to any type of propensity for action type of problem and can be configured to estimate a future probability of an entity. As structured and unstructured data is continuously streamed into the system, the multi-machine learning models can be iteratively retrained through the iterative flow of FIG. 5(c) and the best model can be changed to another one of the multi-machine learning models based on the historical data and the new data as obtained by the system.

FIG. 5(c) illustrates an example flow diagram for the automatic features selection, in accordance with an example implementation. Specifically, FIG. 5(c) is directed to the features selection of the flow at 612.

At 631, the datasets are taken into the feature selection 604. At 632, patterns are identified from the dataset to determine a variable of interest that can be utilized as a feature. At 633, if there were patterns found (Yes), then the flow proceeds to 634, otherwise (No), the flow proceeds to 631 to obtain the next dataset.

At 634, a determination is made as to whether the identified pattern is useful for the analysis that is being executed. If so (Yes), then the flow proceeds to 636, otherwise (No), the flow proceeds to 635 to discard the variable associated with the identified pattern.

At 636, a determination is made as to whether there is missing data in the dataset. If so (Yes), then the flow proceeds to 638 to execute an interpolation process to fill in the data of the dataset, otherwise (No), the flow proceeds to 637 to keep the identified variable as an extracted feature and obtains the next dataset.

At 638, an interpolation technique is determined to fill in the gaps in the data. If such an interpolation technique exists that is applicable to the data (Yes), then the flow proceeds to 640, otherwise (No), the flow proceeds to 639 to discard the instances of missing data.

At 640, the interpolation procedure is selected. At 641, the interpolation procedure is executed on the data to fill in the gaps. At 642, the results of the interpolated data are backtested against historical data to determine if the data is accurate. At 643, if the data is determined to be accurate (Yes), then the variable is kept as an extracted feature and the process proceeds back to 631 to obtain the next dataset. Otherwise (No), the flow proceeds to 640 to attempt a different interpolation procedure.

FIG. 5(e) illustrates a flow for selecting the most important features from the feature generation, in accordance with an example implementation. In example implementations described herein, the features selection criteria is the availability of the feature for the instance. The criteria of availability of a feature is if it exists for all customers in the group. At 650, the datasets and corresponding extracted variables generated from the flow of FIG. 5(c) is provided. At 651, feature transformations are executed on the datasets. At 652, instances are formed from grouping the features. At 653, the instances are split by feature groups. At 654, supervised training is executed on the features and instances. At 655, the instances and corresponding models are then saved into the database.

FIG. 5(f) illustrates a flow for defining hyperparameter ranges, in accordance with an example implementation. At 661, the features from the selection process of FIG. 5(e) are provided. At 662, the instances are split into two subgroups (test set and training set). At 663, a copy of the features are generated. At 664, present feature transformations are conducted. Such feature transformation can include random forest 665, logic regression 666, support vector machines 667, or decision trees 668. The performance of all the models are then compared to determine the best model at 669. At 670, the best model is presented as the result.

FIG. 5(g) illustrates an example flow involving the training, in accordance with an example implementation. The example illustrated in FIG. 5(g) is random forest 680. At 681, the features are provided to conduct a grid search to create several training procedures at 682. The random forest is executed on the grid search at 683, 684, 685, 686 for different parameters to generate different models. The performance metric is then determined for each of the models at 687 to determine the best model at 688. The best model is then returned as a result at 689.

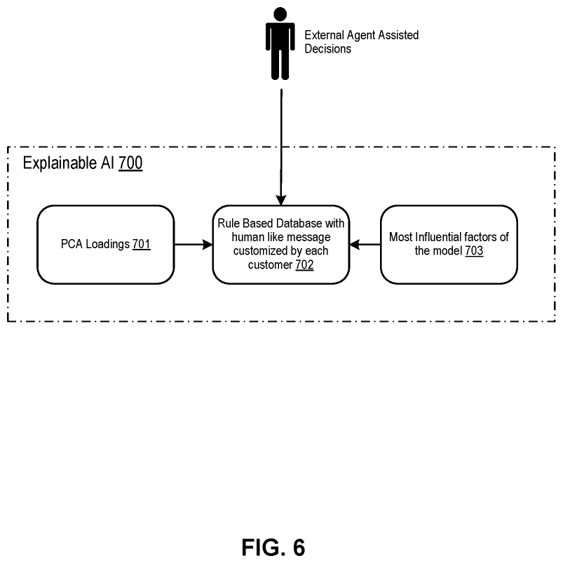

FIG. 6 illustrates an example of the explainable AI, in accordance with an example implementation. Explainable AI 700 includes PCA loadings 701, rule based database with human like message customized by each customer 702, and most influential factors of the model 703. In the process 106 of FIG. 1, the explainable AI 700 is configured to train the model and find the coefficients that explain the model. Note that in latent space, all features are unified in the latent space and their inference can be evaluated equally.

In an example, the raw data is loaded into PCA loadings 701 to apply a transformation that decomposes the original space to the latent space. The coefficients which explain the model are the output of the supervised training. The process trains the model and finds the coefficients that explain the model (in latent space)

Then, the explainable AI 700 determines a top ranking of the coefficients that influence more of the probabilities. The coefficients are ranked based on how much influence it contributes to the features. The way to compute this influence is based on the results of the model.

Subsequently, from the latent space, the explainable AI 700 analyzes and identifies the top-ranking impacted variables in the original space using the linear combination of the covariance of original variables in latent space. From the latent space, the system analyzes what are the top three (e.g., as is preset) most impacted variables in the hidden space through the use of most influential factors of the model 703.

Explainable AI 700 then computes the covariance of the features from the raw data and variables from the latent space. If the covariance is large, the relationship indicates a strong relationship between a feature and a hidden variable. In the case of a strong relationship, the explainable AI 700 thereby indicates that this relationship exists and assigns the feature into the hidden variable explanation.

The results of the top-ranking original variables are provided into the rule based database 702. The data scientist can then add explanatory statements in the rule based database 702 to explain the top ranking of the coefficients and facilitate human understanding.

As illustrated in FIG. 6, the explainable AI 700 results in a rule based database 702 configured to provide an explanation as to which variables most likely impact the model. One Principal Component Analysis is used to change the original domain into the latent domain as shown at 701. To solve this problem, the algorithm computes the square of loadings of the PCA and computes the matrix of distribution of the variables in the latent space. After computing this distribution, the algorithm computes the product between the variables in the original space from the customer vector with the matrix of distribution of the variables in latent space.

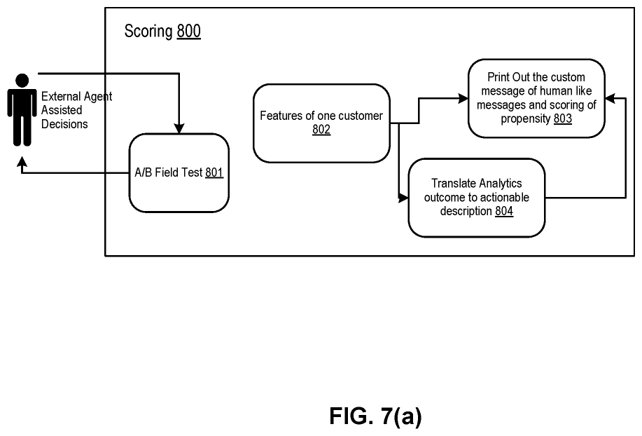

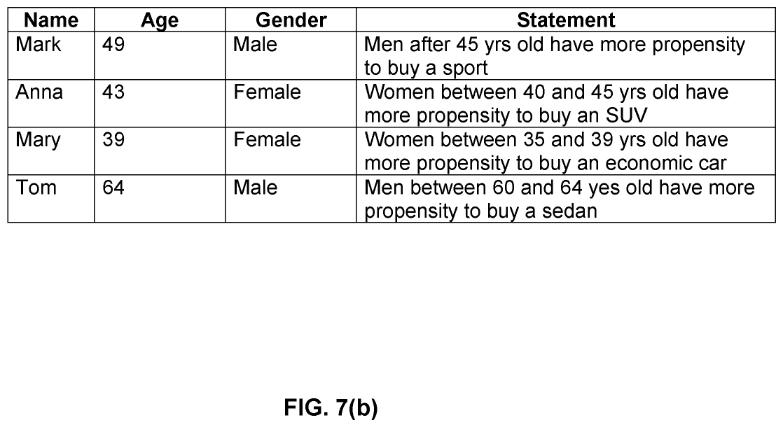

The algorithm selects just the topmost influent latent variables that make the model more explainable and as inference, considers the most influent variables in the original space from each latent variable. The most influential variable in the original space is the explanation of the model. Based on the original space, the data scientist writes a standard message for each variable in the original space that explains how this variable impacts the likelihood of the propensity. This procedure is conducted at 804 of FIG. 7(a).

FIG. 7(a) illustrates an example of the scoring 800, in accordance with an example implementation. Scoring is invoked at 107 of FIG. 1. After the model is trained, it is used to score the instance in the dataset. In this phase, the example implementations translate the analytics outcome into an actionable description. Based on the output of each data score and the influence of factors on the model, the output is published in a dashboard.

The translation from analytics outcome into an actionable description is made by the user who collects the information of the top three features having the most influence and add an actionable statement and transform it in a human-readable information. For example, for an implementation wherein assuming age and gender are top influence features in the model the actionable description could be provided in the manner illustrated in FIG. 7(b). FIG. 7(b) illustrates an example of the output that can be provided with custom messages, in accordance with an example implementation.

At 801, there is functionality to facilitate A/B field testing for an external agent, in which a field test is developed to analyze outcome results on the dash board. At 802, the features of a customer are provided along with a custom, human like message as provided previously in the rule based database as well as the propensity scoring at 803.

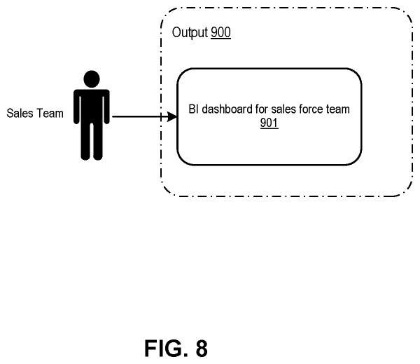

FIG. 8 illustrates an example of the output dashboard 900, in accordance with an example implementation. After scoring, the model system interfaces with the corporate system and then publishes the content of the scoring with the translated analytics outcome on a dashboard 901.

Through the example implementations described herein, this self-adaptive multi-model approach uses data characteristics for selecting features based on source, quality, structured and unstructured data, and unifies all the features in a latent space. The example implementations can thereby provide a best fit of a multi-model using performance criteria, and can be embedded in information technology (IT) systems to support the process of decision-making for the decision makers.

Any company that would like to compute a likelihood of the next action can utilize the example implementations described herein. For example, a retail company may want to compute the likelihood of their customers to make a purchase. Non-government organizations may want to compute the likelihood of potential donors to make a donation. Wholesale companies that focus on business-to-business (B2B) industries can use this invention to improve their sales by better determining when and what their customers will buy. Further, companies can input data through the system described herein and use the output to share the information with revenue-generating teams, such as sales associates, support representatives, and agents.

This self-adaptive, multi-model approach can be a solution to predict a propensity for behavior in Business to Business (B2B) and Business to Consumer arenas. For every use case that needs to define a likelihood of something to happen based on historical behavior, this multi-model approach is an optimal solution for computing this likelihood.

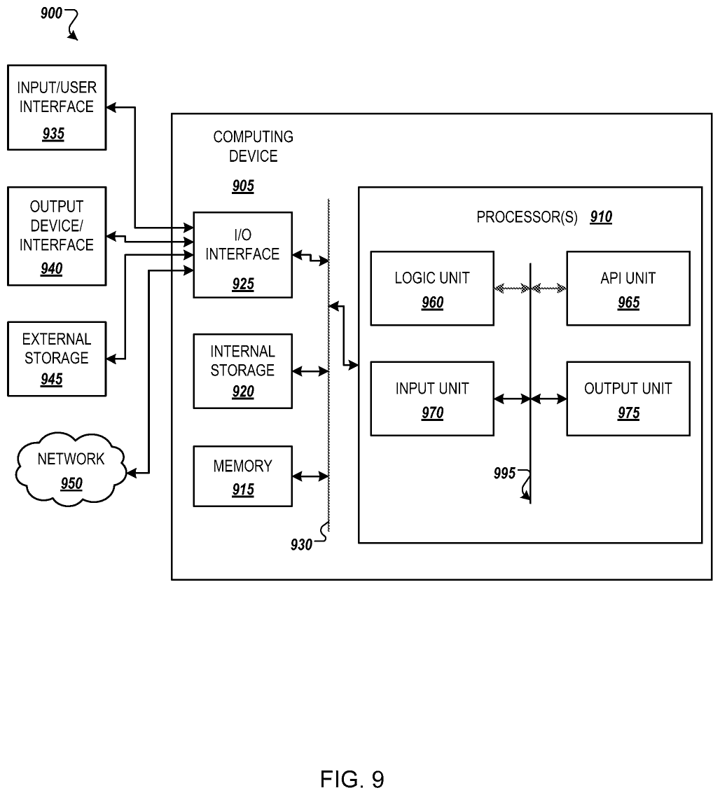

FIG. 9 illustrates an example computing environment with an example computer device suitable for use in some example implementations, such as to facilitate the functionality of all the processes illustrated in FIGS. 1(a) and 1(b). Computer device 905 in computing environment 900 can include one or more processing units, cores, or processors 910, memory 915 (e.g., RAM, ROM, and/or the like), internal storage 920 (e.g., magnetic, optical, solid state storage, and/or organic), and/or IO interface 925, any of which can be coupled on a communication mechanism or bus 930 for communicating information or embedded in the computer device 905. IO interface 925 is also configured to receive images from cameras or provide images to projectors or displays, depending on the desired implementation. Multiple instances of computer device 905 can be utilized to facilitate an implementation over the cloud or as Software as a Service (SaaS), depending on the desired implementation.

Computer device 905 can be communicatively coupled to input/user interface 935 and output device/interface 940. Either one or both of input/user interface 935 and output device/interface 940 can be a wired or wireless interface and can be detachable. Input/user interface 935 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 940 may include a display, television, monitor, printer, speaker, braille, or the like. In some example implementations, input/user interface 935 and output device/interface 940 can be embedded with or physically coupled to the computer device 905. In other example implementations, other computer devices may function as or provide the functions of input/user interface 935 and output device/interface 940 for a computer device 905.

Examples of computer device 905 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 905 can be communicatively coupled (e.g., via IO interface 925) to external storage 945 and network 950 for communicating with any number of networked components, devices, and systems, including one or more computer devices of the same or different configuration. Computer device 905 or any connected computer device can be functioning as, providing services of, or referred to as a server, client, thin server, general machine, special-purpose machine, or another label.

IO interface 925 can include, but is not limited to, wired and/or wireless interfaces using any communication or IO protocols or standards (e.g., Ethernet, 802.11x, Universal System Bus, WiMax, modem, a cellular network protocol, and the like) for communicating information to and/or from at least all the connected components, devices, and network in computing environment 900. Network 950 can be any network or combination of networks (e.g., the Internet, local area network, wide area network, a telephonic network, a cellular network, satellite network, and the like).

Computer device 905 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computer device 905 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 910 can execute under any operating system (OS) (not shown), in a native or virtual environment. One or more applications can be deployed that include logic unit 960, application programming interface (API) unit 965, input unit 970, output unit 975, and inter-unit communication mechanism 995 for the different units to communicate with each other, with the OS, and with other applications (not shown). The described units and elements can be varied in design, function, configuration, or implementation and are not limited to the descriptions provided. Processor(s) 910 can be in the form of hardware processors such as central processing units (CPUs) or in a combination of hardware and software units.

In some example implementations, when information or an execution instruction is received by API unit 965, it may be communicated to one or more other units (e.g., logic unit 960, input unit 970, output unit 975). In some instances, logic unit 960 may be configured to control the information flow among the units and direct the services provided by API unit 965, input unit 970, output unit 975, in some example implementations described above. For example, the flow of one or more processes or implementations may be controlled by logic unit 960 alone or in conjunction with API unit 965. The input unit 970 may be configured to obtain input for the calculations described in the example implementations, and the output unit 975 may be configured to provide output based on the calculations described in example implementations.

Processor(s) 910 can be configured to a) generate time series features from structured data and unstructured data managed in a data lake as illustrated at 612-613 of FIG. 5(b); b) executing a feature selection process on the time series features as illustrated at 614 of FIG. 5(b); c) conducting supervised training on the selected time series features across a plurality of different types of models iteratively to generate a plurality of models at 615-616 of FIG. 5(b); d) selecting a best model from the plurality of models for deployment as shown at 617-619 of FIG. 5(b); and e) continuously iterating a) to d) while the best model exceeds the predetermined criteria as shown at 619 and 620 of FIG. 5(b). Through such example implementations, an analytics model can thereby be automatically generated from structured and unstructured data while being self-adapting in a multi-model approach through the iterative generation of the plurality of models, which can thereby be applied to any type of propensity of action type of problem. The models can thereby output any type of probability of action in accordance with the desired implementation through iterative self-adaptation, utilization of a plurality of machine-learning models, and through the historical behavior data.

Processor(s) 910 can be configured to generate time series features from the structured data and the unstructured data managed in a data lake by applying latent semantic analysis configured to transform text information of the structured data and the unstructured data into a numeric representation; executing recency, frequency, and monetization models on the transformed text information to determine recency features, frequency features, and monetization features; generating the time series features from the recency features, frequency features and the monetization features according to time frames; and applying binarization on ones of the time series features directed to categorical features as illustrated at FIGS. 3, 5(d) and 5(e).

Depending on the desired implementation, the plurality of different types of models can involve one or more of random forest, logic regression, support vector machine, decision tree, or supervised machine learning model as illustrated at FIGS. 5(f) and 5(g).

Processor(s) 910 can be configured to, for receipt of new structured data or unstructured data by the data lake, incorporate the new structured data or unstructured data into the generating of the time series features and reiterating a) to d) while the best model is deployed as illustrated in FIG. 5(b).

Processor(s) 910 can be configured to provide a dashboard configured to intake customized messages for association with factors of the best model; wherein the customized messages are provided as output for output of the best model involving the factors as illustrated in FIGS. 6, 7(a) and 7(b).

Processor(s) 910 can be configured to execute principal component analysis on the time series features to transform the time series features to a latent space; utilize supervised training to determine coefficients of the latent space that influence the best model; and provide the determined coefficients as the factors as illustrated in FIG. 6.

Processor(s) 910 can be configured to generate the time series features from the structured data and the unstructured data managed in a data lake by identifying one or more datasets associated with one or more variables of interest recognized from one or more identified patterns found in the structured data and the unstructured data to adopt as the time series features; and for the one or more datasets having missing data, executing an interpolation process to add data in the datasets; and for back testing of the added data having accuracy within a threshold of historical data, adopting the one or more variables of interest as the time series features as illustrated in FIG. 5(c).

Processor(s) 910 can be configured to execute a feature selection process on the time series features by executing feature transformations on the one or more datasets; forming instances from grouping the time series features; and splitting the instances by feature groups to select the time series features as illustrated in FIG. 5(e).

Processor(s) 910 can be configured to conduct supervised training on the selected time series features across a plurality of different types of models iteratively to generate the plurality of models by conducting grid searches of parameters to generate a plurality of supervised training procedures based on the selected time series features; and executing random forest training on the grid searches of parameters to generate the plurality of different types of models from the plurality of supervised training procedures as illustrated in FIG. 5(g).

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. A method, comprising:
a) generating time series features from structured data and unstructured data managed in a data lake;
b) executing a feature selection process on the time series features;
c) conducting supervised training on the selected time series features across a plurality of different types of models iteratively to generate a plurality of models;
d) selecting a best model from the plurality of models for deployment; and
e) continuously iterating a) to d) while the best model exceeds a predetermined criteria.

2. The method of claim 1, wherein the generating time series features from the structured data and the unstructured data managed in a data lake comprises:
applying latent semantic analysis configured to transform text information of the structured data and the unstructured data into a numeric representation;
executing recency, frequency, and monetization models on the transformed text information to determine recency features, frequency features, and monetization features;
generating the time series features from the recency features, frequency features and the monetization features according to time frames; and
applying binarization on ones of the time series features directed to categorical features.

3. The method of claim 1, wherein the plurality of different types of models comprises one or more of random forest, logic regression, support vector machine, or decision tree.

4. The method of claim 1, wherein, for receipt of new structured data or unstructured data by the data lake, incorporating the new structured data or unstructured data into the generating of the time series features and reiterating a) to d) while the best model is deployed.

5. The method of claim 1, further comprising providing a dashboard configured to intake customized messages for association with factors of the best model;
wherein the customized messages are provided as output for output of the best model involving the factors.

6. The method of claim 1, further comprising:
executing principal component analysis on the time series features to transform the time series features to a latent space;
utilizing supervised training to determine coefficients of the latent space that influence the best model; and
providing the determined coefficients as the factors.

7. The method of claim 1, wherein the generating the time series features from the structured data and the unstructured data managed in a data lake comprises:
identifying one or more datasets associated with one or more variables of interest recognized from one or more identified patterns found in the structured data and the unstructured data to adopt as the time series features;
for the one or more datasets having missing data:
executing an interpolation process to add data in the datasets;
for back testing of the added data having accuracy within a threshold of historical data, adopting the one or more variables of interest as the time series features.

8. The method of claim 7, wherein the executing a feature selection process on the time series features comprises:
executing feature transformations on the one or more datasets;
forming instances from grouping the time series features;
splitting the instances by feature groups to select the time series features.

9. The method of claim 1, wherein the conducting supervised training on the selected time series features across a plurality of different types of models iteratively to generate the plurality of models comprises:
conducting grid searches of parameters to generate a plurality of supervised training procedures based on the selected time series features;
executing random forest training on the grid searches of parameters to generate the plurality of different types of models from the plurality of supervised training procedures.

10. A non-transitory computer readable medium, storing instructions for executing a process, the instructions comprising:
a) generating time series features from structured data and unstructured data managed in a data lake;
b) executing a feature selection process on the time series features;
c) conducting supervised training on the selected time series features across a plurality of different types of models iteratively to generate a plurality of models;
d) selecting a best model from the plurality of models for deployment; and
e) continuously iterating a) to d) while the best model exceeds a predetermined criteria.

11. The non-transitory computer readable medium of claim 10, wherein the generating time series features from the structured data and the unstructured data managed in a data lake comprises:
applying latent semantic analysis configured to transform text information of the structured data and the unstructured data into a numeric representation;
executing recency, frequency, and monetization models on the transformed text information to determine recency features, frequency features, and monetization features;
generating the time series features from the recency features, frequency features and the monetization features according to time frames; and
applying binarization on ones of the time series features directed to categorical features.

12. The non-transitory computer readable medium of claim 10, wherein the plurality of different types of models comprises one or more of random forest, logic regression, support vector machine or decision tree.

13. The non-transitory computer readable medium of claim 10, wherein, for receipt of new structured data or unstructured data by the data lake, incorporating the new structured data or unstructured data into the generating of the time series features and reiterating a) to d) while the best model is deployed.

14. The non-transitory computer readable medium of claim 10, further comprising providing a dashboard configured to intake customized messages for association with factors of the best model;
wherein the customized messages are provided as output for output of the best model involving the factors.

15. The non-transitory computer readable medium of claim 10, further comprising:
executing principal component analysis on the time series features to transform the time series features to a latent space;
utilizing supervised training to determine coefficients of the latent space that influence the best model; and
providing the determined coefficients as the factors.
